(19) United States
(12) Patent Application Publication
(10) Pub. No.: US 2010/0097562 A1
(43) Pub. Date: Apr. 22, 2010

(54) LIQUID CRYSTAL COMPOSITION AND LIQUID CRYSTAL DISPLAY COMPRISING THE SAME

(75) Inventors: So-Youn Park, Suwon-si (KR); Nam-Seok Lee, Suwon-si (KR); Su-Jung Huh, Yongin-si (KR); Duck-Jong Suh, Seoul (KR); Mi-Soon Kim, Asan-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/575,038

(22) Filed: Oct. 7, 2009

(30) Foreign Application Priority Data
Oct. 21, 2008 (KR) 2008-103196

(51) Int. Cl. C09K 19/02; C09K 19/30

(52) U.S. Cl. 349/167; 349/182; 252/299.63

(57) ABSTRACT

The present invention discloses a liquid crystal composition and a liquid crystal display including the same. The liquid crystal composition includes: a first non-polar liquid crystal compound represented by the following Formula 1; a second non-polar liquid crystal compound represented by the following Formula 2; and a polar liquid crystal compound:

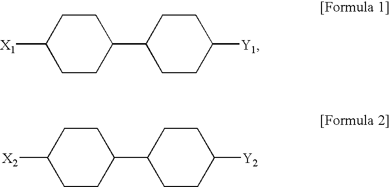

wherein X₁ is an alkyl or alkenyl group including one to three carbon atoms; Y₁ is an alkyl or alkenyl group including one or two carbon atoms; X₂ is an alkyl or alkenyl group including at least two carbon atoms; and Y₂ is an alkyl or alkenyl group including three or four carbon atoms.

### CROSS REFERENCE TO RELATED APPLICATION

This application claims priority from and the benefit of Korean Patent Application No. 2008-103196, filed on Oct. 21, 2008, which is hereby incorporated by reference for all purposes as if fully set forth herein.

### BACKGROUND OF THE INVENTION

1. Field of the Invention

The present invention relates to a liquid crystal composition and a liquid crystal display including the same. More particularly, the present invention relates to a liquid crystal composition capable of operating at a low voltage to ensure low power consumption characteristics of a liquid crystal display and having an improved response rate, and a liquid crystal display including the same.

2. Discussion of the Background

Recently, as an information-based society has developed, demands for high-performance displays that display various kinds of information including images, graphics, letters, etc. have been rapidly increased to rapidly transmit various kinds of information. As a result, the display industry has been making great strides to satisfy these demands.

Particularly, liquid crystal displays (LCDs) have been developed for several years as advanced next-generation display devices, because the LCDs may have a low power consumption as compared with cathode ray tubes (CRTs), may be designed to have a low weight and small thickness, and may not emit harmful electromagnetic waves. Recently, LCDs have been the subject of steadily increasing attention together with plasma display panels (PDPs), because the LCDs may be suitable for large-screen display devices with a size of at least 30 inches, satisfying the requirements of the current high image quality digital broadcasting systems.

An LCD displays images by interposing liquid crystals, which represent intermediate phases between solid and liquid, between two substrates, and by varying the alignment of the liquid crystal molecules in relation to an electric field formed between two electrodes disposed on the two substrates. Such LCDs are widely used in electronic watches, electronic calculators, personal computers, and televisions, and are specifically designed to be adapted to a particular use.

In an ultramobile notebook PC, which recently has been extensively used, an LCD is designed to have a compact and slim shape and a low weight due to a high comfort requirement for users of a mobile display device. However, if such an ultramobile notebook PC requires a heavy eight-cell battery instead of a four-cell battery, it may not meet the high comfort requirement. Therefore, there has been a need for a LCD simultaneously satisfying the requirements of low power consumption and a high response rate. To this end, many attempts have been made to develop liquid crystals having high dielectric anisotropy and low rotational viscosity.

### SUMMARY OF THE INVENTION

The present invention provides a liquid crystal composition capable of operating at a low voltage to ensure low power consumption characteristics of a liquid crystal display and having an improved response rate, and a liquid crystal display including the same.

The present invention also provides a liquid crystal display that may show excellent display characteristics and meet a high comfort requirement as a mobile display device.

Additional features of the invention will be set forth in the description which follows, and in part will be apparent from the description, or may be learned by practice of the invention.

The present invention discloses a liquid crystal composition including: 10 wt %-30 wt % of a first non-polar liquid crystal compound represented by the following Formula 1; 5 wt %-15 wt % of a second non-polar liquid crystal compound represented by the following Formula 2; and 55 wt %-80 wt % of a polar liquid crystal compound:

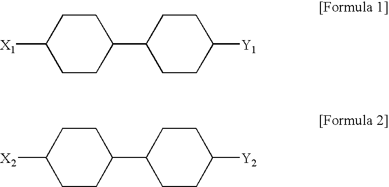

X₁ is an alkyl or alkenyl group including one to three carbon atoms; Y₁ is an alkyl or alkenyl group including one or two carbon atoms; X₂ is an alkyl or alkenyl group including at least two carbon atoms; and Y₂ is an alkyl or alkenyl group including three or four carbon atoms.

The present invention also discloses a liquid crystal display including: a first substrate including a thin film transistor and a pixel electrode; a second substrate including a common electrode; and the liquid crystal composition according to the present invention, disposed between the first substrate and the second substrate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic sectional view showing a liquid crystal display according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Spatially relative terms, such as “beneath,” “below,” “above,” “upper,” or the like, may be used to describe an element or feature's relationship to another element(s) or feature(s) as, for example, shown in the figures. It will be understood that the spatially relative terms are intended to encompass different orientations of the device in use or operation in addition to the orientation depicted in the figures.

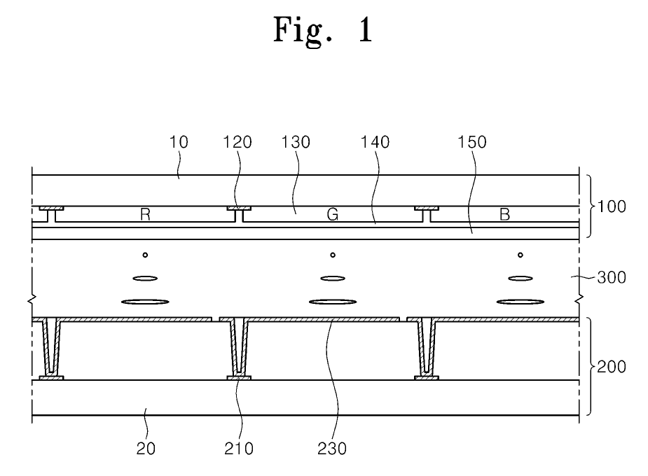

Description will now be made with reference to the liquid crystal display according to an exemplary embodiment of the present invention. FIG. 1 is a schematic sectional view showing a liquid crystal display according to an exemplary embodiment of the present invention.

As shown in FIG. 1, the liquid crystal display according to an exemplary embodiment of the present invention includes a lower substrate 200 and an upper substrate 100, and a liquid crystal composition 300 interposed between the lower substrate 200 and the upper substrate 100.

The lower substrate 200 is provided with a plurality of pixels formed on a second dielectric substrate 20 in the form of a matrix. Each pixel includes a thin film transistor 210 connected to a data line (not shown), through which data signals are transmitted, and a gate line (not shown), through which gate signals are transmitted, and a pixel electrode 230 connected to the thin film transistor 210.

The thin film transistor 210 supplies the data signals transmitted from the data line selectively to the pixel electrode 230 in response to the gate signals transmitted from the gate line. To accomplish this, the thin film transistor 210 includes a gate electrode connected to the gate line; a source electrode connected to the data line; a drain electrode connected to the pixel electrode 230; an active layer overlapping with the gate electrode, with a gate insulating layer (not shown) interposed between the active layer and the gate electrode, while forming a channel between the source electrode and the drain electrode; and an ohmic contact layer making ohmic contact between the active layer and the source and drain electrodes.

The pixel electrode 230 is formed so as to be overlapped with a color filter R, G, and B 130 of the upper substrate 100 at each pixel region, and is connected to the drain electrode exposed through a contact hole. The pixel electrode 230 generates a potential difference in cooperation with a common electrode 150 by the pixel data signals supplied through the thin film transistor 210. The potential difference causes rotation in the liquid crystal composition 300, and light transmission is determined by the degree of rotation of the liquid crystal composition 300.

The upper substrate 100 includes a black matrix 120 formed on a first dielectric substrate 10 to prevent light leakage, the color filter 130 formed on the region divided by the black matrix 120, an overcoat layer 140 formed on the color filter 130 and the black matrix 120, and the common electrode 150 formed on the overcoat layer 140.

The black matrix 120 blocks light transmitted through a region where the liquid crystal composition 300 cannot be controlled. In addition, the black matrix 120 interrupts direct light irradiation toward the channel of the thin film transistor 210 to prevent a light leakage current from being generated in the thin film transistor 210. The black matrix 120 may be made of an opaque organic material or an opaque metal.

The color filter 130 includes red, green, and blue color filters R, G, and B 130 to realize colors, and is disposed on the upper substrate 100 corresponding to each of the pixels provided on the thin film transistor 210. The red, green, and blue color filters R, G, and B 130 each absorb or transmit light with a specific wavelength through a red, green, or blue pigment contained therein, thereby realizing a red, green, or blue color. Additionally, various colors are realized through the additive color mixing of the red, green, and/or blue light transmitted through each of the red, green, and blue color filters R, G, and B 130.

The overcoat layer 140 is formed on the black matrix 120 and the color filter 130 to protect the color filter 130 and to reduce a difference in height that may be generated between the black matrix 120 and the color filter 130. The overcoat layer 140 may include a transparent organic material.

The common electrode 150 is formed on the overcoat layer 140. The difference between the common voltage applied to the common electrode 150 and the pixel voltage applied to the pixel electrode 230 results in an electric field formed in the liquid crystal composition 300, thereby controlling the light transmission of the liquid crystal composition 300.

The liquid crystal composition 300 includes a first non-polar liquid crystal compound represented by the following Formula 1, a second non-polar liquid crystal compound represented by the following Formula 2, and a polar liquid crystal compound:

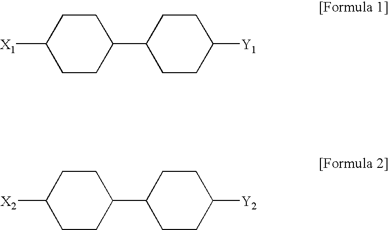

X₁ is an alkyl or alkenyl group having 1 to 3 carbon atoms; Y₁ is an alkyl or alkenyl group having 1 or 2 carbon atoms; X₂ is an alkyl or alkenyl group having 2, 3 or more carbon atoms; and Y₂ is an alkyl or alkenyl group having 3 or 4 carbon atoms.

The highest response rate obtained from the currently produced liquid crystals with a drive voltage of 4V or less is about 16 ms at 3.3V. Such liquid crystal composition with a drive voltage of 3.3V should have a dielectric anisotropy as high as Δε=11 to ensure a contrast ratio (CR) corresponding to at least 90% of the contrast ratio of known products with a drive voltage of 4V or higher.

To allow liquid crystals to be driven at a low voltage of 2.9V or less in a twisted nematic (TN) mode, the liquid crystals should have a high dielectric anisotropy so that they are driven at a lower drive voltage as compared to the liquid crystals with a drive voltage of 3.3V. Therefore, a liquid crystal composition having a higher polarity is required to realize an increased dielectric anisotropy and a drive voltage of 2.9 V or less. However, the liquid crystal composition may generally have difficulty in ensuring a high response rate (16 ms or less).

The liquid crystal display using the above-mentioned liquid crystal composition according to an exemplary embodiment of the present invention enables low-voltage driving and realizes an improved response rate.

The first non-polar liquid crystal compound is a superlow-viscosity (SLV) non-polar liquid crystal compound, and is used in the liquid crystal composition in an amount of 10 wt %-30 wt %. If the first non-polar liquid crystal compound is used in an amount less than 10 wt %, the liquid crystal composition cannot provide a sufficient response rate of 16 ms or less. On the other hand, if the first non-polar liquid crystal compound is used in an amount greater than 30 wt %, the liquid crystal composition provides an improved response rate but shows a decreased dielectric anisotropy, and thus cannot ensure a sufficient contrast ratio.

The second non-polar liquid crystal compound is used in the liquid crystal composition in an amount of 5 wt %-15 wt %. If the second non-polar liquid crystal compound is used in an amount less than 5 wt %, the liquid crystal composition shows an excessively increased dielectric anisotropy, resulting in poor long-term reliability, for example, formation of after-images. On the other hand, if the second non-polar liquid crystal compound is used in an amount greater than 15 wt %, the liquid crystal composition shows an excessively low dielectric anisotropy and cannot display a sufficiently low black luminance, resulting in an inadequate contrast ratio and poor display quality of the LCD panel.

Polar liquid crystal compounds that may be used in the liquid crystal composition include polar liquid crystal compounds having at least three cyclohexane rings or benzene rings and containing at least two fluoro groups at the end thereof. Examples of such polar liquid crystal compounds include the liquid crystal compounds represented by the following Formula 3. The polar liquid crystal compounds listed in Formula 3 are shown except for the fluoro groups attached to the end(s) thereof.

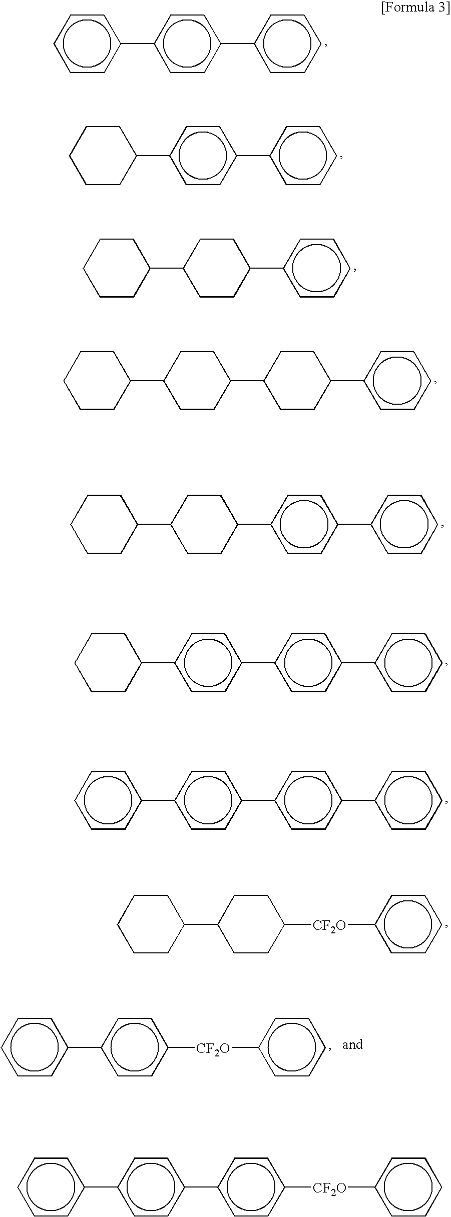

In Formula 3, at least two fluoro groups are present at the end of each compound, and various functional groups such as hydrogen atoms or hydrocarbyl groups may be present at the other end, to which any fluoro groups are not added, as long as such functional groups do not adversely affect the physical properties of the liquid crystal composition. However, the present invention is not limited thereto. For example, functional groups such as C₅H₈O— may be present.

The polar liquid crystal compound is used in the liquid crystal composition in an amount of 55 wt %-80 wt %. If the polar liquid crystal compound is used in an amount less than 55 wt %, the liquid crystal composition shows a low dielectric anisotropy and cannot satisfy an adequate contrast ratio, resulting in poor display quality of the LCD panel. On the other hand, if the polar liquid crystal compound is used in an amount greater than 80 wt %, the liquid crystal composition cannot ensure a high response rate and causes poor long-term reliability of the LCD panel.

The liquid crystal composition may include 35 wt %-50 wt % of at least one polar liquid crystal compound selected from the following three types of compounds and 20 wt %-30 wt % of at least one polar liquid crystal compounds selected from the above-listed polar liquid crystal compounds, based on the total weight of the composition:

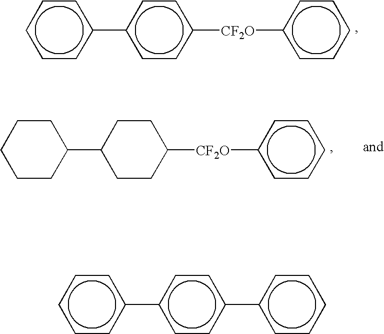

The present exemplary embodiment may provide significantly improved display quality including improved response rates and contrast ratios.

The liquid crystal composition according to the present exemplary embodiment has a refractive index of 0.1-0.12, a dielectric anisotropy of 15-20, and a rotational viscosity of 90 mPas-110 mPas. As a result, the liquid crystal composition may provide an improved response rate under a low drive voltage and may realize improved display quality including a contrast ratio.

A liquid crystal composition having the physical properties described in the Table 2, shown below, was prepared from the compounds listed in Table 1. A TN-mode liquid crystal display was fabricated by injecting the liquid crystal composition through a one drop filling (ODF) process. The liquid crystal display was designed to have a cell gap of 3.6 μm.

TABLE 1

| | Amount |
|---|---|
| Liquid Crystal Composition | (wt %) |
| Non-polar compounds | |
| 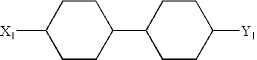 | 20.5 |
| 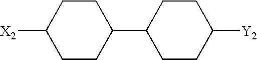 | 11 |
| Polar compounds | |
| 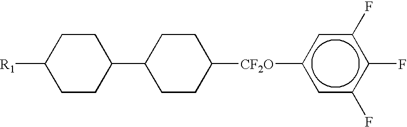 | 18.5 |
| 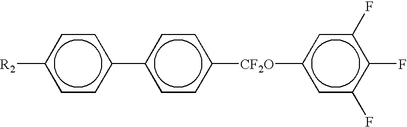 | 15 |
| 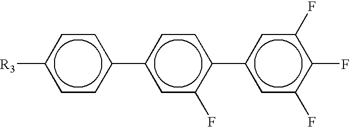 | 10 |
| 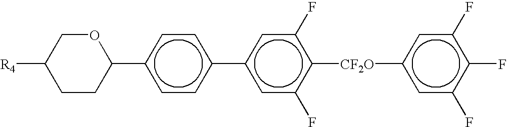 | 12 |
| 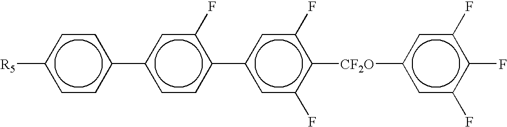 | 6 |
| 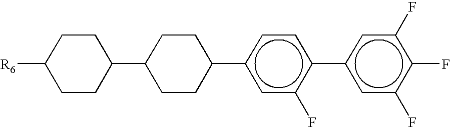 | 7 |

In Table 1, X₁ is an alkyl or alkenyl group having 1 to 3 carbon atoms; Y₁ is an alkyl or alkenyl group having 1 or 2 carbon atoms; X₂ is an alkyl or alkenyl group having 2, 3 or more carbon atoms; and Y₂ is an alkyl or alkenyl group having 3 or 4 carbon atoms. Each of R₁, R₂, R₃, R₄ and R₅ represents an akyl or alkenyl group.

TABLE 2

| Item | Value |
|---|---|
| Rotational Viscosity | 105 mPas |
| Phase Transition Temperature | 75° C. |
| Dielectric Anisotropy | 18 |
| Refractive Index | 0.113 |

The liquid crystal display was subjected to measurement of its response rate at a drive voltage of 2.5V and contrast ratio. After the measurement, the liquid crystal display showed excellent quality as demonstrated by a response rate of 16 ms and a contrast ratio of 500:1.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal composition, comprising:
10 wt %-30 wt % of a first non-polar liquid crystal compound represented by Formula 1;
5 wt %-15 wt % of a second non-polar liquid crystal compound represented by Formula 2; and
55 wt %-80 wt % of a polar liquid crystal compound having at least three cyclohexane rings or benzene rings and containing at least two fluoro groups at an end thereof: 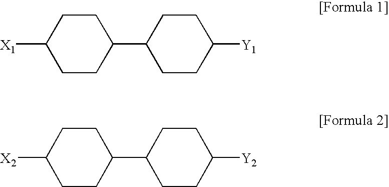
wherein X₁ is an alkyl or alkenyl group comprising one to three carbon atoms; Y₁ is an alkyl or alkenyl group comprising one or two carbon atoms; X₂ is an alkyl or alkenyl group comprising at least two carbon atoms; and Y₂ is an alkyl or alkenyl group comprising three or four carbon atoms.

2. The liquid crystal composition of claim 1, wherein the polar liquid crystal compound comprises at least one compound selected from compounds represented by Formula 3, and contains at least two fluoro groups at an end thereof:

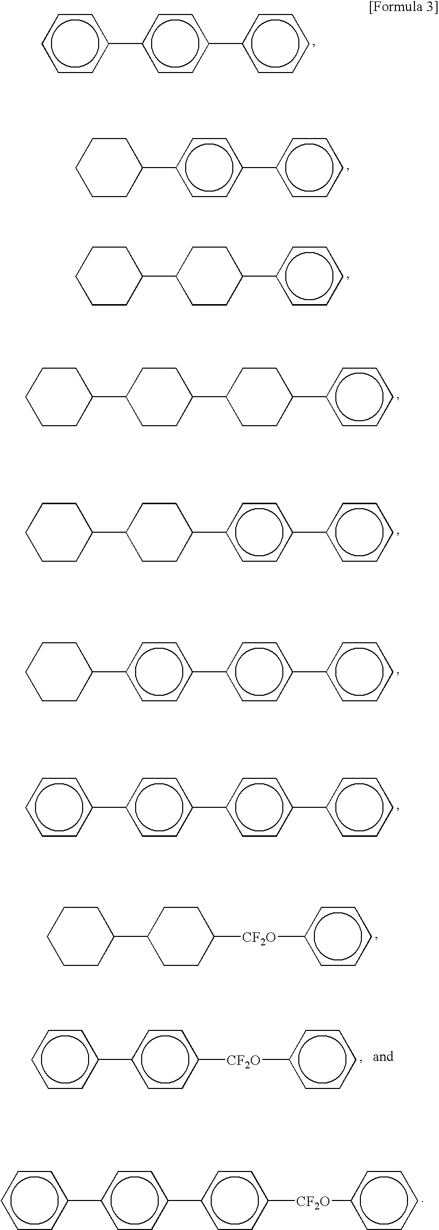

3. The liquid crystal composition of claim 1, wherein the liquid crystal composition has a dielectric anisotropy of about 15 to about 20.

4. The liquid crystal composition of claim 1, wherein the liquid crystal composition has a refractive index of about 0.1 to about 0.12.

5. The liquid crystal composition of claim 1, wherein the liquid crystal composition has a rotational viscosity of about 90 mPas to about 110 mPas.

6. A liquid crystal display, comprising:
a first substrate comprising a thin film transistor and a pixel electrode;
a second substrate opposite to the first substrate and having a common electrode; and
a liquid crystal composition disposed between the first substrate and the second substrate,
wherein the liquid crystal composition comprises 10 wt %-30 wt % of a first non-polar liquid crystal compound represented by Formula 1; 5 wt %-15 wt % of a second non-polar liquid crystal compound represented by Formula 2; and 55 wt %-80 wt % of a polar liquid crystal compound comprising at least three cyclohexane rings or benzene rings and containing at least two fluoro groups at an end thereof: 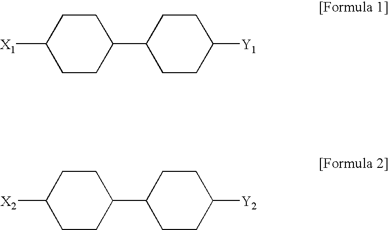
wherein X₁ is an alkyl or alkenyl group comprising one to three carbon atoms; Y₁ is an alkyl or alkenyl group comprising one or two carbon atoms; X₂ is an alkyl or alkenyl group comprising at least two carbon atoms; and Y₂ is an alkyl or alkenyl group comprising three or four carbon atoms.

7. The liquid crystal display of claim 6, wherein the polar liquid crystal compound comprises at least one compound selected from compounds represented by Formula 3, and contains at least two fluoro groups at an end thereof:

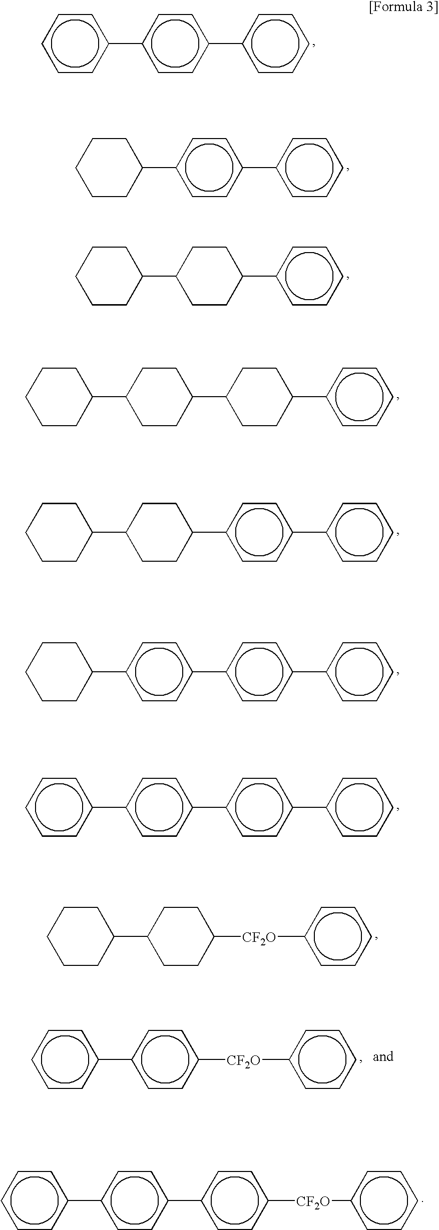

8. The liquid crystal display of claim 6, wherein the liquid crystal composition has a dielectric anisotropy of about 15 to about 20.

9. The liquid crystal display of claim 6, wherein the liquid crystal composition has a refractive index of about 0.1 to about 0.12.

10. The liquid crystal display of claim 6, wherein the liquid crystal composition has a rotational viscosity of about 90 mPas to about 110 mPas.

11. The liquid crystal display of claim 6, wherein the first substrate and the second substrate are spaced apart from each other by a distance of about 3.4 μm to about 4.0 μm.

12. The liquid crystal display of claim 6, wherein the liquid crystal display has a drive voltage of about 2.4V to about 2.9V.
